(19) United States
(12) Patent Application Publication
(10) Pub. No.: US 2026/0031958 A1
(43) Pub. Date: Jan. 29, 2026

(54) PROCEDURES TO SUPPORT PSFCH REPORTING IN SIDELINK COMMUNICATION

(71) Applicant: KONINKLIJKE PHILIPS N.V., EINDHOVEN (NL)

(72) Inventors: Thomas Fehrenbach, BERLIN (DE); Cornelius Hellge, BERLIN (DE); Thomas Wirth, BERLIN (DE); Thomas Schierl, BERLIN (DE); Sarun Selvanesan, BERLIN (DE); Baris GÖKTEPE, BERLIN (DE)

(21) Appl. No.: 19/348,891

(22) Filed: Oct. 3, 2025

Related U.S. Application Data
(63) Continuation of application No. 17/651,238, filed on Feb. 15, 2022.
Application No. 17/651,238 is a continuation of application No. PCT/EP2020/072261, filed on Aug. 7, 2020.

(30) Foreign Application Priority Data
Aug. 16, 2019 (EP) 19192133.7

(51) Int. Cl. H04L 5/00; H04L 5/16; H04W 72/0446

(52) U.S. Cl. CPC H04L 5/0055; H04L 5/16; H04W 72/0446

(57) ABSTRACT

A device configured to operate in a wireless communication network being operated so as to include a feedback channel providing feedback resources to acknowledge reception of transmitted messages transmitted in the wireless communication network is to acknowledge a received message e.g., a control message of a PSSCH, by transmitting a first feedback message using a specific feedback resource; and for awaiting an acknowledge transmission. The device is configured to await reception of a second acknowledge message transmitted by use of the same or another specific feedback resource. The device is configured for postponing or omitting transmission of the first feedback message so as to receive the second feedback message.

### CROSS-REFERENCE TO RELATED APPLICATIONS

This application is a continuation of U.S. application Ser. No. 17/651,238 filed Feb. 15, 2022 which is a continuation of International Application No. PCT/EP2020/072261, filed Aug. 7, 2020, which is incorporated herein by reference in its entirety, and additionally claims priority from European Application No. EP 19192133.7, filed Aug. 16, 2019, which is also incorporated herein by reference in its entirety.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length, which may depend on the numerology used for a particular bandwidth part (BWP). E.g. the slot duration with a subcarrier spacing (SCS) of 15 kHz might be 1 ms, where the slot duration reduces to 0.5 ms for an SCS of 30 kHz, or to 0.25 ms for an SCS of 60 KHz. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR, New Radio, standard.

The wireless network or communication system depicted in FIG. 1 may by a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 4 UEs are outside of the coverage 200 of a base station, rather, it means that the respective mode 4 UEs are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the mode 3 UEs 202, 204 also mode 4 UEs 206, 208, 210 are present.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

Naturally, in the above-mentioned use cases sidelink communication is not limited to a communication within a group. Rather, the sidelink communication may be among any of UEs, like any pair of UEs.

It is noted that the information in the above section is only for enhancing the understanding of the background of the invention and therefore it may contain information that does not form conventional technology that is already known to a person of ordinary skill in the art.

### SUMMARY

An embodiment may have a device configured to operate in a wireless communication network being operated so as to include a feedback channel providing feedback resources to acknowledge reception of transmitted messages transmitted in the wireless communication network; wherein the device is to acknowledge a received message e.g., a control message of a PSSCH, by transmitting a first feedback message using a specific feedback resource; and for awaiting reception of a second feedback message; wherein the device is configured to await reception of the second feedback message transmitted by use of the same or another specific feedback resource; wherein the device is configured for postponing or omitting transmission of the first feedback message so as to receive the second feedback message.

Another embodiment may have a device configured to operate in a wireless communication network being operated so as to include a feedback channel providing feedback resources to acknowledge reception of transmitted messages transmitted in the wireless communication network; wherein the device is to acknowledge a received message (e.g., a control message of a PSSCH) by transmitting a first feedback message using a specific feedback resource; and for awaiting an acknowledge transmission; wherein the device is configured to await a second acknowledge message transmitted by use of the specific feedback resource; wherein the device is configured for transmitting the first feedback message and for assuming the second feedback message to include a predefined content.

Another embodiment may have a wireless communication network being operated so as to include a feedback channel providing feedback resources to acknowledge reception of messages transmitted in the wireless communication network; wherein a number of messages is larger when compared to a number of feedback messages enabled by the feedback resources; the network including: a device configured to operate in a wireless communication network being operated so as to include a feedback channel providing feedback resources to acknowledge reception of transmitted messages transmitted in the wireless communication network; wherein the device is to acknowledge a received message e.g., a control message of a PSSCH, by transmitting a first feedback message using a specific feedback resource; and for awaiting reception of a second feedback message; wherein the device is configured to await reception of the second feedback message transmitted by use of the same or another specific feedback resource; wherein the device is configured for postponing or omitting transmission of the first feedback message so as to receive the second feedback message, and a device configured to operate in a wireless communication network being operated so as to include a feedback channel providing feedback resources to acknowledge reception of transmitted messages transmitted in the wireless communication network; wherein the device is to acknowledge a received message (e.g., a control message of a PSSCH) by transmitting a first feedback message using a specific feedback resource; and for awaiting an acknowledge transmission; wherein the device is configured to await a second acknowledge message transmitted by use of the specific feedback resource; wherein the device is configured for transmitting the first feedback message and for assuming the second feedback message to include a predefined content.

According to an embodiment, a device configured to operate in a wireless communication network being operated so as to comprise a feedback channel providing feedback resources to acknowledge reception of transmitted messages transmitted in the wireless communication network; is configured to acknowledge a received message e.g., a control message of a PSSCH, by transmitting a first feedback message using a specific feedback resource. The device is configured for awaiting an acknowledge transmission; wherein the device is configured to await reception of a second acknowledge message transmitted by use of the same or another specific feedback resource; wherein the device is configured for postponing or omitting transmission of the first feedback message so as to receive the second feedback message.

According to an embodiment, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources is configured to acknowledge a received message (e.g., a control message of a PSSCH) by transmitting a first feedback message using a specific feedback resource; and for awaiting an acknowledge transmission. The device is configured to await a second acknowledge message transmitted by use of the specific feedback resource. The device is configured for transmitting the first feedback message and for assuming the second feedback message to comprise a predefined content.

According to an embodiment, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources is organized such that one or more messages transmitted to a receiver are to be acknowledged by the receiver in a combined feedback message. The device is configured sense the network for transmitted messages, to determine a receiver of the transmitted messages and for selecting a slot for an own transmission based on the sensed transmitted message to avoid feedback collisions.

According to an embodiment, e.g., for resource avoidance based on already transmitted messages, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources. The network is organized such resources used for transmission of a message are associated with resources used for corresponding feedback signals. Therein the device is configured to determine a first receiver of a first transmitted message; and, for transmitting an own message to a second receiver, avoid resources that the receiver of the own transmission is expected to use to also send its feedback message using the same resources as the first receiver.

According to an embodiment, e.g., for resource avoidance based on already transmitted messages, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources. The network is organized such resources used for transmission of a message are associated with resources used for corresponding feedback signals. The device is configured for determine a first receiver of a first transmitted message; and, for transmitting an own message to the first receiver, use resources that are deemed to be used by the first receiver to send its feedback message.

According to an embodiment, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources is organized such resources used for transmission of a message are associated with resources used for corresponding feedback signals. The device is to determine a number of feedback signals in a feedback resource, and wherein another device (receiver or transmitter of feedback) is to determine a same number of feedback signals.

Further embodiments relate to a wireless communication network, to methods for operating devices and to a computer program or a computer readable digital storage medium having such a program.

### BRIEF DESCRIPTION OF THE DRAWINGS

Embodiments of the present invention will be detailed subsequently referring to the appended drawings, in which:

FIG. 1a-1b is a schematic representation of an example of a terrestrial wireless network, wherein FIG. 1(a) illustrates a core network and one or more radio access networks, and FIG. 1(b) is a schematic representation of an example of a radio access network RAN;

FIG. 2 is a schematic representation of an in-coverage scenario in which two UEs directly communicating with each other are both connected to a base station;

FIG. 3 is a schematic representation of an out-of-coverage scenario in which the UEs directly communicating with each other are either not connected to a base station, although they may be physically within a cell of a wireless communication network;

FIG. 4a shows a schematic diagram for illustrating a time-based mapping of acknowledgements;

FIG. 4b shows a schematic diagram for illustrating a frequency-based mapping of acknowledgements;

FIG. 4c shows a schematic diagram for illustrating a mixed-based mapping;

FIG. 4d shows a schematic representation of a possible implementation of a reporting window in which resources allocated to different UE over a plurality of slots and subchannels;

FIGS. 5a-5b show example implementation rules for transmitting messages according to embodiments; and

FIG. 6 shows a schematic block diagram of a device in accordance with embodiments.

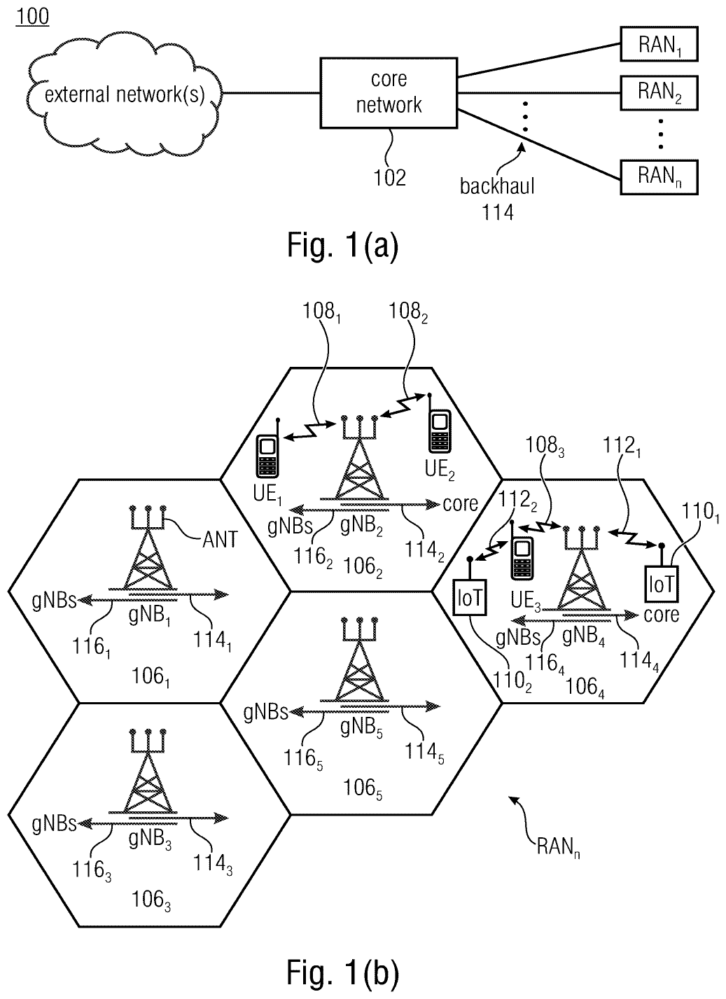

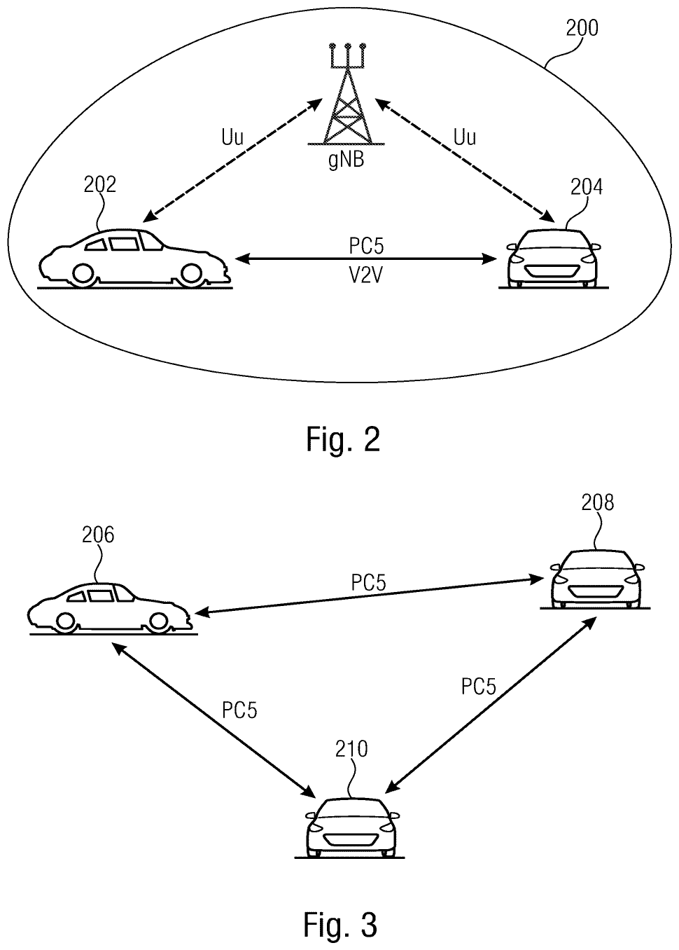

### DETAILED DESCRIPTION OF THE INVENTION

Embodiments of the present invention are now described in more detail with reference to the accompanying drawings, in which the same or similar elements have the same reference signs assigned.

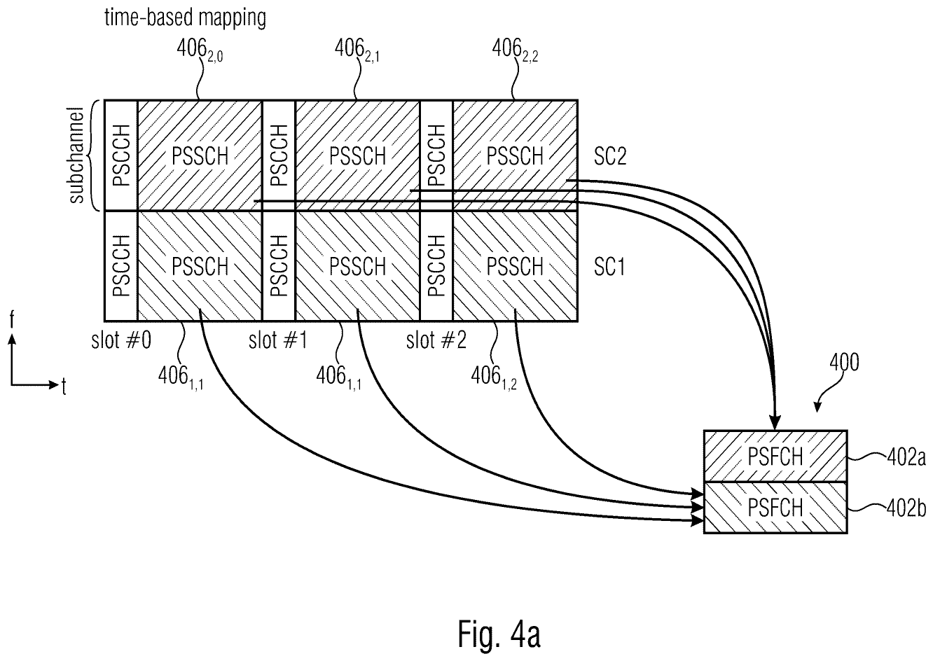

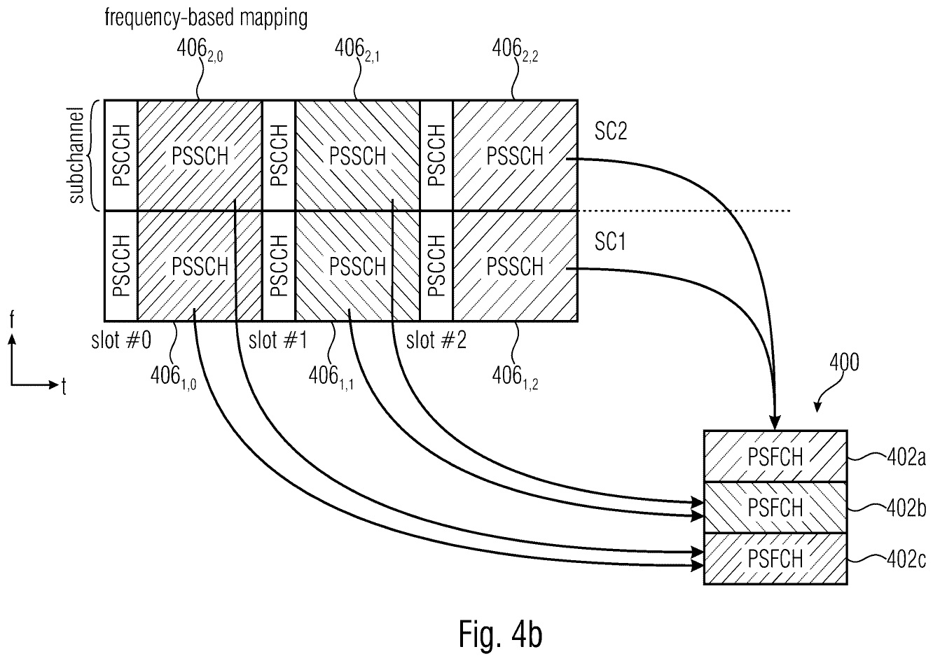

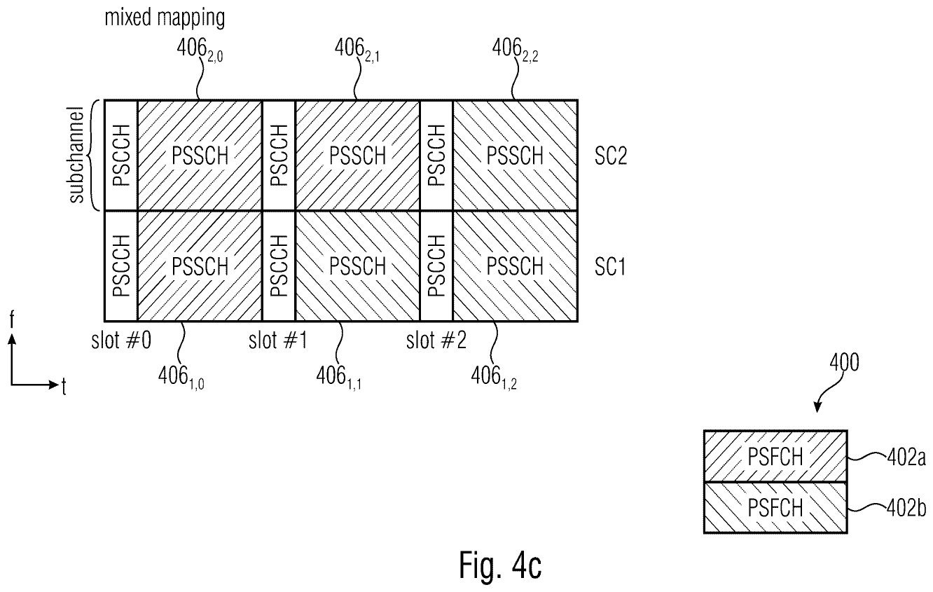

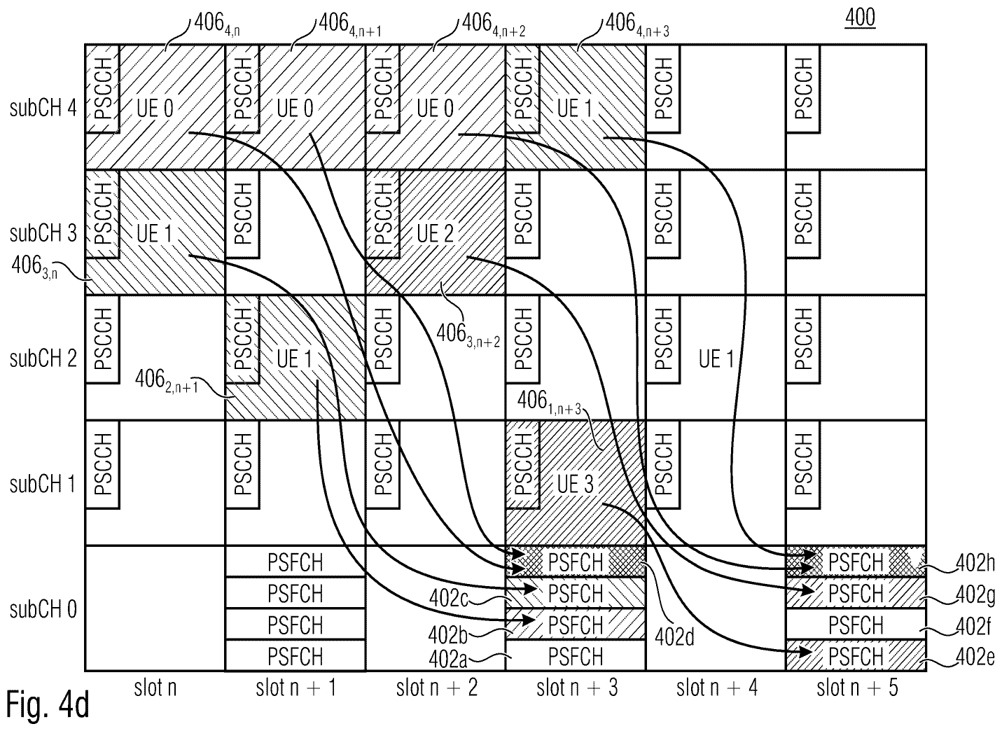

FIGS. 4a-c shoes a schematic representation of a Physical Sidelink Feedback Channel (PSFCH) reporting window 400. Such a PSFCH reporting window 400. In FIG. 4a a time-based mapping is shown in which a plurality of PSSCH of a plurality of slots and separated by sub-channels may be acknowledged with a common acknowledge 402a, 402b respectively.

In FIG. 4b a frequency-based mapping is shown in which an acknowledgement 402a-c may be used to acknowledge a plurality of resources 406 or PSSCH of different slots.

In FIG. 4c a mixed-based mapping is shown combining the frequency-based and the time-based mapping as indicated for slot #1 in which subchannel 2, SC2, is acknowledged by use of acknowledgement 402a and subchannel 1, SC1, is acknowledged by use of acknowledgement 402b as described for the time-based mapping, whilst in other slots slot #0 and slot #2 a configuration like the frequency-based mapping is used.

FIG. 4d shows a schematic representation of a possible implementation of the reporting window 400 in which resources allocated to different UE over a plurality of slots and subchannels, subCHs, are mapped to a plurality of acknowledgements 402, wherein each acknowledgement 402 may be used one, e.g., acknowledgement 402b or more often, e.g., for a same device as shown for acknowledgement 402d or for different devices as shown for acknowledgement 402h.

It has been agreed that NR V2X supports a PSFCH periodicity N which is larger than one. Hence, a PSFCH does not exist in all of the slots (i.e., there may be slots without PSFCH) but appears with a certain periodicity which is a parameter of the pool configuration, as depicted in FIG. 4d. Furthermore, an implicit mapping between the PSSCH and the PSFCH resources is assumed at least for the timing. The actual PSFCH resource that is used in a PSFCH slot may be indicated in the corresponding PSCCH or implicit. For example, any transmission within the first PSFCH reporting window (Slot n, n+1) in subchannel 4 is associated to the PSFCH resource in slot n+3 which is at the top.

However, this causes also certain issues. Mainly three different issues have been identified:

### 1. PSFCH TX-RX Overlap

This issue arises in case the UE has to transmit a PSFCH for a received PSSCH but also expects to receive a PSFCH for PSSCH that it transmitted even before.

### 2. PSFCH TX to Multiple UEs

This issue appears to be mainly a problem if a PSFCH collision has arisen and also the same subchannel is to be used.

3. PSFCH TX with Multiple HARQ ACKs to Same UE

We assume here that the UE used PSSCH resources which are linked to the same PSFCH resource. Otherwise this issue would be categorized more in issue 2.

There is thus a request to provide for reliable feedback messages in wireless communication networks.

An object of the present invention is to,

### Solutions

The embodiments described herein provide enhancements to wireless communication networks that use a feedback channel, in particular a Physical Sidelink Feedback Channel (PSFCH) for acknowledging (ACK/NACK) reception of data signals or messages.

More particular but not limited hereto, wireless communication networks are addressed that foresee a lower number of feedback messages when compared to a number of messages that may be subjected to a feedback. An example is the explained periodicity of N>1. That is, more than one message is probably acknowledged with a single feedback.

Note: For every data transmission on the data channel (e.g. PSSCH; Physical Sidelink Shared Channel) there is a control message (e.g. SCI). We call this transmission resource. The feedback for multiple data transmissions in time and/or frequency is mapped to one feedback resource on the feedback channel (e.g. PSSCH). The feedback resource can also be part of a control channel comprising different control messages.

### PSFCH Prioritization (Solution for Issue 1)

In case the UE has received the control message (e.g. SCI) for the reception before its transmission it may decide based on certain criteria, such as:
the QoS,
packet size,
buffer status,
delay budget and/or
decoding outcome (HARQ result to be reported), e.g. if the feedback to be transmitted is a NACK, the UE may decide not to transmit and rely that the other UE not receiving the PSFCH will assume a NACK
a combination thereof
   of the associated packets, to drop or postpone its transmission. The same criteria could also be applied to the case that the UE has transmitted an PSSCH and received after that an PSSCH for which it has to provide the HARQ feedback in the same PSFCH slot as it expects the HARQ feedback for its own transmission. Based on that criteria, the UE would decide whether to favor the feedback channel (e.g. PSFCH) reception or feedback channel (e.g. PSFCH) transmission.

As may be seen from the above, one or more parameters or criteria may be related to a priority level. Therefore, the priority level may become a part of the QoS and/or vice versa.

In another embodiment, the UE would favor transmitting the feedback channel and assume a NACK for the feedback channel that it missed. Hence, it would perform a retransmission for this one.

For example, a device configured to operate in a wireless communication network being operated so as to comprise a feedback channel providing feedback resources to acknowledge reception of transmitted messages transmitted in the wireless communication network; may be configured for acknowledging a received message e.g., a control message of a PSSCH, by transmitting a first feedback message using a specific feedback resource; and for awaiting an acknowledge transmission. The device is configured to await reception of a second acknowledge message transmitted by use of the same or another specific feedback resource and for postponing or omitting transmission of the first feedback message so as to receive the second feedback message.

Optionally but not necessarily, the number of transmitted messages is larger when compared to a number of feedback resources. However the finding of this aspect is not directly linked to this feature such that the device may also be implemented for any number of messages and/or resources.

The device may, optionally, be adapted such that the first and second feedback message are to be transceived within the same time interval, (e.g TTI or slot).

The device may, optionally, be adapted such that, alternatively or in addition to the feedback message, the first and second feedback resource are to be transceived within the same time interval (e.g TTI or slot).

The device may be configured for postponing or omitting the transmission of the first feedback message in case the first feedback message is a negative feedback which allows the dedicated receiver to indicate the missing message as a negative feedback.

The device may be configured for transmitting the first feedback message responsive to a successful decoding of the received message using the specific resource.

The device may be configured for postponing or omitting the transmission of the first feedback message based on at least one of:
the QoS of the received message and/or the message to be acknowledged, for example, indicated as a priority level
a packet size of the received message and/or the message to be acknowledged,
a buffer status of the device,
a battery status of the device,
a delay budget of the device and/or
a decoding outcome (HARQ result to be reported).

For example, the device may be configured for operating according to a half-duplex scheme and for prioritizing either transmission of the first feedback message or reception of the second feedback message over the other.

Assuming, e.g., a NACK, in case of a missing message may also be implemented in connection with another predefined content. That is, the situation leading to a missing message may itself be interpreted as message or content.

For example, a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources may be configured to acknowledge a received message (e.g., a control message of a PSSCH) by transmitting a first feedback message using a specific feedback resource; and for awaiting an acknowledge transmission. The device may be configured to await a second acknowledge message transmitted by use of the specific feedback resource. The device may further be configured for transmitting the first feedback message and for assuming the second feedback message to comprise a predefined content, for example, but not limited to a NACK. That is, such a device may transmit an interpret a missing message.

Such a device may be implemented such that the predefined content is a negative feedback (NACK).

Such a device may be configured for retransmitting a message being a basis for the second feedback signal responsive to the assumed negative feedback.

### Enhanced Sensing Procedures Depending on the PSFCH Configuration (Solution for Issue 2)

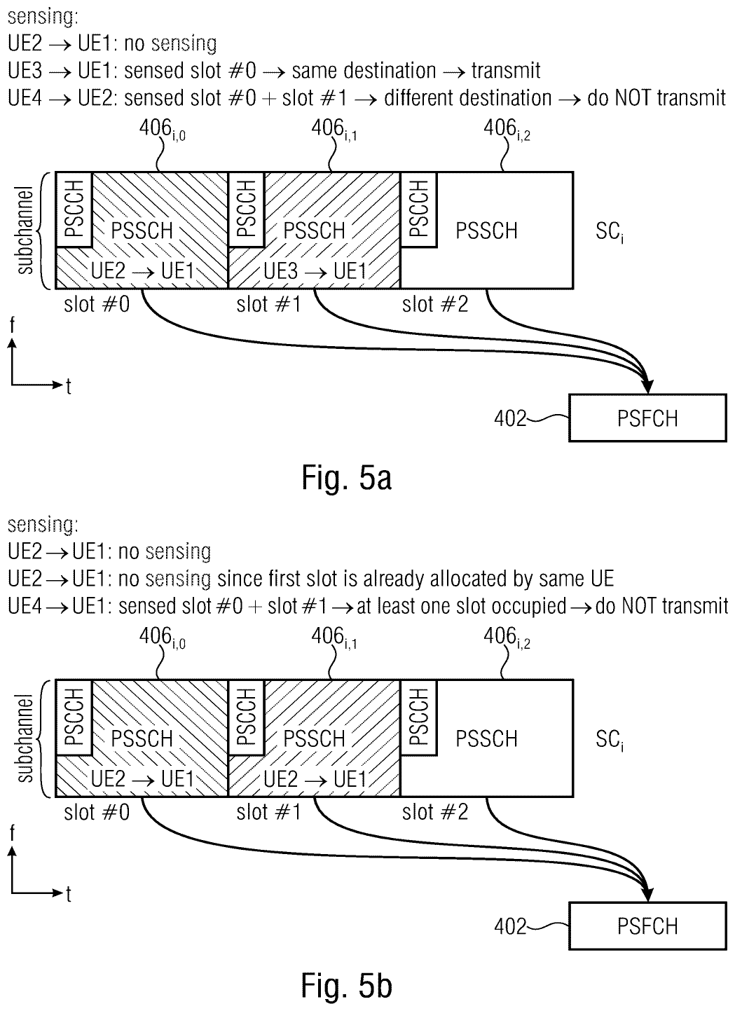

The UEs may perform additional sensing based on the feedback channel periodicity. Since multiple data channel (e.g. PSSCH) resources are associated with a single PSFCH control channel resource, a collision happens in case two different receiving UEs have to report on the same feedback channel resource. Hence, embodiments provide an enhanced sensing mechanism where a sending UE before performing a data transmission senses the previous data resources associated to the same feedback channel resource where the sending UE intends to perform a transmission and decides which resource to use based on one or more of the following criteria:
1. Don't use a transmission resource if any one of the previous transmission resources (except own transmissions) mapping to the same feedback resource is occupied (see FIG. 5b). That is, a resource that is regarded as possibly or likely resulting in collisions may be avoided.
   In FIG. 5b, for example, the sensing may incorporate that UE₂ transmits to UE₁ using resource 406_{i,0}, no sensing is performed. In resource 406_{i,1}, UE₂ still transmits to UE₁ and, as the first slot is already allocated to the same UE, no sensing is performed. A further UE, e.g., UE₄ has sensed slot #0 and slot #1, e.g., resources 406_{i,0} and 406_{i,1} and senses that at last one slot was occupied and, thus, does not transmit.
2. Choose a potential transmission resource candidate. Decode the control data, e.g. PSCCH, of previous transmissions mapping to the same feedback resource as the potential candidate and extract the UE destination ID. Furthermore, don't use the candidate transmission resource, if any of the previous control messages, is addressed to a different UE destination ID than the UE destination ID to which the candidate transmission is addressed to (see FIG. 5a). That is, a UE may determine that a same UE is addressed and may transmit its own transmission in knowledge that the receiver (same UE) may acknowledge the set of received messages with a same feedback resource.
   In FIG. 5a, the sensing may incorporate that UE₂ transmits to UE₁ such that no sensing has to be performed by UE₁. However, UE₃ sensed slot #3, e.g., resource 406_{i,0} and determines that it has the same destination for its message, e.g., UE₁. To the contrary, UE₄ senses also slot #0 and slot #1, e.g., resource 406_{i,1}, and determines that it has a different destination. Therefore, it does not transmit in slot #2.
3. Favor transmit resources which are addressed to a same UE: Decode the control data of previous transmissions mapping to the same feedback resource and extract the destination ID and use a transmission resource, if any of the previous control messages, is addressed to the same destination ID as the ID of the UE for which the transmission is. That is, the transmitter may prioritize or select a resource for transmission that is known to be associated to with an PSFCH that will (at least probably) be used by the receiver for acknowledging a prior transmission.

Such a device may implement a resource avoidance based on already transmitted messages and/or may be implemented to operate in a wireless communication network being operated so as to comprise a feedback channel providing feedback resources to acknowledge reception of transmitted messages transmitted in the wireless communication network; wherein a number of transmitted messages is larger when compared to a number of feedback resources. The network may be organized such that resources used for transmission of a message are associated with resources used for corresponding feedback signals. The device may be configured to determine a first receiver of a first transmitted message; and, for transmitting an own message to a second receiver, avoid resources that the receiver of the own transmission is expected to use to also send its feedback message using the same resources as the first receiver.

Alternatively or in addition, a device aiming for resource avoidance based on already transmitted messages may be configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources. The network is, for example, organized such that resources used for transmission of a message are associated with resources used for corresponding feedback signals. The device may be configured to determine a first receiver of a first transmitted message; and, for transmitting an own message to the first receiver, use resources that are deemed to be used by the first receiver to send its feedback message.

In other words, FIGS. 5a-b: show schematic diagrams illustrating an enhanced sensing based on PSFCH reporting window.

In a further embodiment, the transmitting UE is still allowed to transmit in a transmission resource for which one of the previous mentioned criteria applies, if it is an HARQ-less transmission, i.e. it does not expect a HARQ feedback for this transmission and the one or more receiver UE (that is, the transmission may be a broadcast, a groupcast or multicast or a unicast) is UEs are also aware of that fact, hence it will not report in the feedback resource (PSFCH).

### Multi-Bit HARQ-ACK Reporting in Feedback Resources (PSFCH) (Solution for Issue 3)

### Dynamic Length Reporting:

To support different reporting length, i.e. different number of HARQ-ACK bits, the communicating UEs may agree on a certain number of bits using e.g. RRC signaling. This would force them to report the same number of bits regardless of the number of transmissions. For example, if the feedback channel (PSFCH) periodicity N=3, then two UEs could agree on 3 HARQ-ACK bits. In this case, the receiving UE would report 3 bits each bit corresponding to the HARQ-ACK feedback of a transmission or a slot. Even if there was no transmission in one of the slots, the UE would report a NACK for that slot. Hence, it would also report a NACK in case a control message (e.g. SCI) was missed and the transmitter UE would schedule a retransmission.

In case the UEs agree on less bits than slots per PSFCH reporting window, then the transmitter UE may combine the feedback of the different transmissions to match the number of bits to report. For example, N=2 and bits to report=1, then the UE would perform an AND operation of the two HARQ-ACK bits and transmit the result of the AND operation in the PSFCH.

Such a device may be configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources. The network may be organized such that resources used for transmission of a message are associated with resources used for corresponding feedback signals The device is to determine a number of feedback signals in a feedback resource, and wherein another device (receiver or transmitter of feedback) is to determine a same number of feedback signals, said feature may be implemented in the other device, wherein, for a comparable behavior, the device may operate accordingly in view of the determination of a different device.

The device may be configured for using a preconfigured number of feedback signals as default.

The device may be configured to transmit to another device a number of feedback signals to use.

The device may be configured to receive from another device a number of feedback signals to use.

The device may be configured to determine the number of feedback resources from the PSFCH periodicity which is signaled by the network as part of the resource pool configuration.

The number of feedback resources may be equal to the PSFCH periodicity, wherein other implementations may also be used.

The device may be configured to perform a feedback reduction operation, if the number of feedback signals is less than the number of transmissions or the number of associated transmission resource or associated slots.

The feedback reduction operation may be an AND operation, wherein different operations may also be used.

### Fixed Length Reporting:

The number of bits to report could also be a function of the control channel (PSFCH) periodicity N. For example, if N is configured=3, all UEs would report 3 bits, where each bit corresponds to the feedback of the corresponding slot or transmission.

Devices according to embodiments may implemented as transceiver. Devices may comprise one or more of:
a user equipment;
a mobile or immobile base station,
a mobile terminal,
a stationary terminal,
a cellular IoT-UE,
a vehicular UE,
a group leader UE (GL),
an IoT or narrowband IoT, NB-IoT, device,
a ground based vehicle,
an aerial vehicle,
a drone,
a moving base station,
a road side unit (RSU),
a building, and
any other item or device provided with network connectivity enabling the item/device to communicate using the wireless communication network, e.g., a sensor or actuator.

A device in accordance with this aspect may be configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources The network may be organized such that one or more messages transmitted to a receiver are to be acknowledged by the receiver in a combined feedback message. The device is configured to sense the network for transmitted messages, to determine a receiver of the transmitted messages and for selecting a slot for an own transmission based on the sensed transmitted message to avoid feedback collisions.

Some or all of the feedback messages for one resource may refer to transmitted messages in different or consecutive time intervals (e.g. slots or TTIs).

A device of this aspect may; to avoid feedback collisions, select the transmission resource so that the own transmission is acknowledged by the receiver of the own transmission together with a message of the transmitted messages and/or that the own transmission is acknowledged by the receiver of the own transmission without colliding with the transmissions of other acknowledgements.

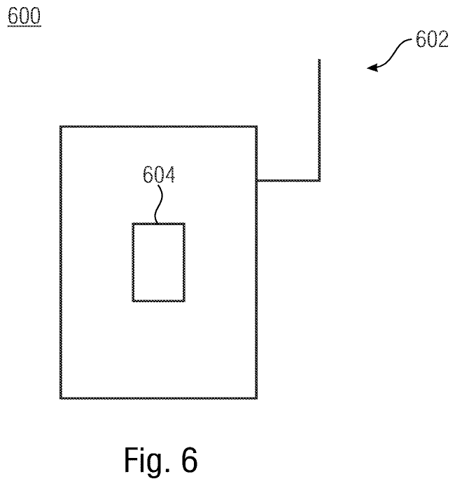

Devices in accordance with one or more aspects or issues may comprise one or more elements, as shown in FIG. 6 for a device 600 which may be in accordance with the given examples. Device 600 may comprise a wireless interface 602 to allow communication in one or more bands or channels, e.g., a communication channel and/or a sidelink channel. Further, the device may comprise a control unit 604 configured for determining results described herein and/or to control parts of apparatus 600 according to an implemented behavior.

The device 600 may be or comprise a transceiver and/or may comprise one or more of a user equipment;
a mobile or immobile base station,
a mobile terminal,
a stationary terminal,
a cellular IoT-UE,
a vehicular UE,
a group leader UE (GL),
an IoT or narrowband IoT, NB-IoT, device,
a ground based vehicle,
an aerial vehicle,
a drone,
a moving base station,
a road side unit (RSU),
a building, and
any other item or device provided with network connectivity enabling the item/device to communicate using the wireless communication network, e.g., a sensor or actuator.

A wireless communication network in accordance with embodiments may be operated so as to comprise a feedback channel providing feedback resources to acknowledge reception of messages transmitted in the wireless communication network; wherein a number of messages is larger when compared to a number of feedback messages enabled by the feedback resources; the network comprising: at least two devices according to one of the described embodiments.

Such a network may further comprise one or more base stations.

Such a base station may be implemented as mobile or immobile base station and comprises one or more of
a macro cell base station,
   a small cell base station,
   a central unit of a base station,
   a distributed unit of a base station,
   a road side unit,
   a UE,
   a group leader (GL),
   a relay,
   a remote radio head,
   an AMF,
   an SMF,
   a core network entity,
   a mobile edge computing entity,
   a network slice as in the NR or 5G core context, and
   any transmission/reception point, TRP, enabling an item or a device to communicate using the wireless communication network, the item or device being provided with network connectivity to communicate using the wireless communication network.

Embodiments also relate to the following:

### 1. Introduction

The work item for NR V2X was approved in RAN #83, and revised in RAN #84 [1], and the following objectives were identified in relation to resource allocation:

1. NR sidelink: Specify NR sidelink solutions necessary to support sidelink unicast, sidelink groupcast,
and sidelink broadcast for V2X services, considering in-network coverage, out-of-network coverage,
and partial network coverage.

```
Sidelink physical layer procedures as per the study outcome
  HARQ procedures [RAN1 , RAN2]
  CSI acquisition for unicast [RAN1]
    CQI/RI reporting is supported and they are always reported together. No PMI
    reporting is supported in this work. Multi-rank PSSCH transmission is
    supported up to two antenna ports.
    In sidelink, CSI is delivered using PSSCH (including PSSCH containing CSI only)
    using the resource allocation procedure for data transmission.
  Power control [RAN1 , RAN2]
```

Furthermore, in RAN1 #97 the following agreements, conclusions and working assumptions have been made [2]:

### Agreements for Power Control:

For sidelink transmit power control,
   Total sidelink transmit power is the same in the symbols used for PSCCH/PSSCH transmissions in a slot.
      FFS whether/how to handle simultaneous transmission of sidelink and uplink
   The maximum SL transmit power is (pre-) configured to the TX UE.
      FFS on details (e.g., whether the maximum power is dependent of parameters such as the priority of PSCCH/PSSCH).
For the SL open-loop power control, a UE can be configured to use DL pathloss (between TX UE and gNB) only, SL pathloss (between TX UE and RX UE) only, or both DL pathloss and SL pathloss.
When the SL open-loop power control is configured to use both DL pathloss and SL pathloss,
   The minimum of the power values given by open-loop power control based on DL pathloss and the open-loop power control based on SL pathloss is taken.
      Working assumption: P0 and alpha values are separately (pre-) configured for DL pathloss and SL pathloss.

### Agreements for Tx-Rx Distance:

For at least option 1 based TX-RX distance-based HARQ feedback for groupcast,
   A UE transmits HARQ feedback for the PSSCH if TX-RX distance is smaller or equal to the communication range requirement. Otherwise, the UE does not transmit HARQ feedback for the PSSCH
      TX UE's location is indicated by SCI associated with the PSSCH.
         Details FFS
      The TX-RX distance is estimated by RX UE based on its own location and TX UE location.
      The used communication range requirement for a PSSCH is known after decoding SCI associated with the PSSCH
         FFS implicit or explicit
         FFS how to define location

### Agreements for PSFCH Definition:

For the period of N slot(s) of PSFCH resource, N=2 and N=4 are additionally supported.
For a PSSCH transmission with its last symbol in slot n, when the corresponding HARQ feedback is due for transmission, it is expected to be in slot n+a where a is the smallest integer larger than or equal to K with the condition that slot n+a contains PSFCH resources.
   FFS details of K.
At least for the case when the PSFCH in a slot is in response to a single PSSCH:
   Implicit mechanism is used to determine at least frequency and/or code domain resource of PSFCH, within a configured resource pool. At least the following parameters are used in the implicit mechanism:
      Slot index (FFS details) associated with PSCCH/PSSCH/PSFCH.
      Sub-channel(s) (FFS details) associated with PSCCH/PSSCH
      Identifier (FFS details) to distinguish each RX UE in a group for Option 2 groupcast HARQ feedback
      FFS detailed applicability of the above parameters.
      FFS: Other parameters (e.g. SL-RSRP/SINR, Layer-1 source ID, location information, etc.)

### Conclusion:

Study further whether/how to handle/avoid the following cases for PSFCH transmission and reception:
   Case 1 (PSFCH TX/RX overlap): A UE transmitted a PSSCH and received SCI scheduling another PSSCH where PSFCH resources corresponding the two PSSCHs appear in the same slot.
   Case 2 (PSFCH TX to multiple UEs): A UE received SCI from different UEs and the associated PSFCHs appear in the same slot.
   Case 3 (PSFCH TX with multiple HARQ feedback to the same UE): A UE received multiple SCI from the same UE and the associated PSFCHs appear in the same slot.

In this contribution, embodiments propose an SCI signaling design, possible HARQ operations for unicast communications and a power control mechanism.

### 2. SCI Signaling Design

In the NR V2X study item [3], it has been agreed that at least Layer-1 source and destination IDs and the HARQ process ID are conveyed in the SCI. Furthermore, a field in the SCI indicating whether the associated PSSCH is a retransmission or a new transmission, such as the NDI, is required to avoid ambiguity between the UEs. Hence, the SCI has to include at least the following fields for supporting transmissions with HARQ operations:
L1 Destination ID,
L1 Source ID,
HARQ Process ID,
NDI

Since HARQ feedback operations have been agreed to be used for unicast and groupcast communications, these transmissions would need the abovementioned fields. However for broadcast communications, HARQ will not be applied and hence the HARQ-related fields can be removed, thus reducing the SCI payload size. The remaining bits may be used to achieve a lower code rate, which contributes to a higher reliability of the SCI. In this case, the SCI for scheduling a broadcast PSSCH has to include the L1 Source ID field. Furthermore, the blind decoding effort would be decreased in the case where resource pools are segregated based on cast-types, since only one specific SCI format would be transmitted per resource pool. This is discussed in further detail in our accompanying contribution in [4]. It would hence be advantageous to maintain different SCI formats depending on the communication type.

Proposal 1: Embodiments propose to support different SCI formats for different communication types, with at least one for unicast and groupcast, and one for broadcast communications.

If different SCI formats are supported based on the communication type, the relevant SCI format can be specified in the respective resource pool configuration itself. This would alleviate the need for UEs to blind decode and detect all SCI formats, so that UEs only have to decode the relevant SCI format. This reduces UE processing requirements as well as improves power consumption at the UE.

Proposal 2: Embodiments propose that the resource pool configuration contains the SCI formats to be monitored by the UE.

### 2.1. Dual Control Channel

In our accompanying contribution in [4], we discuss a dual-control channel design based on the operation modes of the UEs. This design incorporates a control channel for SCIs used for Mode 1 transmissions only, and an additional control channel TDMed with the first one, solely used for Mode 2 transmissions. However, Mode 2 UEs have to be able to decode the first Mode 1 control channel in order to determine potentially empty or available resources. Hence, the CRC of these SCI messages cannot be scrambled by the destination L1 ID. Instead, the destination L1 ID could be conveyed as an extra SCI field, such that the destination UE can detect its transmission and Mode 2 UEs are aware of resources reserved for Mode 1 transmissions. This provides the advantage of minimizing collisions between UEs operating in Mode 1 and Mode 2.

Proposal 3: Embodiments implement propose that the CRC of an SCI is not scrambled by the destination L1 ID to allow Mode 2 UEs to detect Mode 1 transmissions.

### 2.2. CBG HARQ or NR V2X

In the NR V2X SI, it has been agreed that if HARQ is enabled, the UE generates at least an ACK or a NACK for a received transmission [3]. At this point, it is a valid question as to whether CBG-based HARQ feedback has to be supported on the SL. This highly depends on whether transmissions spanning several time and/or frequency units are supported.

Partial collisions might occur if the transmission of larger data packets, spanning multiple time-frequency resources, overlaps with short data packets, spanning a single time-frequency resource, being transmitted by a close by UE. In this case, the advantages of using a per CBG HARQ-ACK-based reporting is quite obvious. Due to the differing interference situation of each individual resource unit, the retransmission would benefit from the per-CBG HARQ-ACK. However, for the case of equally sized transmissions, which might collide with each other, CBG HARQ-ACK would not be worth the increased reporting overhead.

Proposal 4: Embodiments implement to support CBG-based HARQ-ACK at least for the case of transmissions spanning multiple time and/or frequency resources.

### 3. HARQ Operation for Unicast

For SL unicast and groupcast operations, HARQ feedback and HARQ combining has been studied and agreed in [3]. The receiving UE generates HARQ feedback for an incoming transmission and conveys it to the transmitting UE via the PSFCH. The time gap between PSSCH and transmitting the associated PSFCH is (pre-) configured for UEs operating in Mode 1 or Mode 2 [3]. Furthermore, the PSFCH periodicity N is part of the resource pool configuration [2].

For N=1 designing an implicit association between PSSCH and PSFCH is not an issue and can be realized depending on certain global parameters, as agreed in the last meeting [5]. However, for N>1, assuming that there is one PSFCH per sub channel, the multiplexing among UEs and their feedback transmissions leads to three main issues that were identified in the last meeting RAN1.

### 3.1. PSFCH TX-RX Overlap

The issue can be described as the scenario where a UE has to transmit HARQ feedback on the PSFCH for a received data transmission, but also expects to receive another HARQ feedback on the PSFCH, at the same time slot, for a data packet which was transmitted by the UE earlier.

There are two possible outcomes to this scenario, depending on which “event” took place first. For example, consider event 1 to be when UE₁ receives an SCI corresponding to a transmission by a UE₂, which contains information regarding the time gap after which UE₁ should transmit the HARQ feedback. Event 2 is when UE₁ transmits an SCI to a UE₃, which contains information regarding the time gap after which UE₁ should receive the HARQ feedback from to UE₃. If event 1 occurs first, UE₁ can accordingly define the SCI in event 2 such that there is no overlap in HARQ feedback transmission and reception. UE₁ could decide based on certain criteria, such as the QoS of the associated packets, to alter the feedback information sent to UE₃ in event 2, in order to avoid PSFCH collisions.

However, in the case where event 2 occurs first and the SCI in event 1 dictates that UE₁ should transmit feedback on the same PSFCH resource that UE₁ is expecting to receive feedback from event 2, there is a half-duplex problem that arises. UE₁ now has to decide, on the same PSFCH resource, whether to transmit the feedback from event 1, or receive the feedback from event 2. It can use the same criteria described earlier, but here it would have to favor either the PSFCH transmission or PSFCH reception.

Proposal 5: Prioritize PSFCH transmissions/receptions based on a criteria, such as QoS, in cases of possible PSFCH resource collisions.

### 3.2. PSFCH TX to Multiple VES

When multiple UEs are expected to transmit HARQ feedbacks on a PSFCH resource in the same time slot, based on the SCIs received from transmitter UEs, there can be three different scenarios with respect to the sub channels being used by the UEs for transmitting the feedback on the PSFCH, which are listed below:
Feedback is transmitted on the same sub channel of the PSFCH.
Feedback is transmitted on different contiguous sub channels of the PSFCH.
Feedback is transmitted on different non-contiguous sub channels of the PSFCH

There are two possible solutions to the first scenario. One solution is where the UEs transmitting the feedback may provide multiple HARQ-ACK bits in the PSFCH to separate UEs. However, the issue of how the receivers are to interpret the bits has to be studied. An implicit linking of the PSSCH and the PSFCH would simplify this issue in the sense that the order of bits could be uniquely mapped to the transmissions. This would enable UEs, during the sensing process itself, to avoid collisions on the PSFCH. The only case when a collision could occur is if two transmitting UEs select the same PSSCH and PSFCH resource. However, this also means a full collision has happened and the receiver UE probably would not be able to decode the corresponding PSSCHs correctly. However, since retransmissions are also implicitly linked to the PSSCH resource, a collision of the retransmissions can occur, and a mechanism to avoid this has to be studied.

While the second scenario does not seem to be a problem, the third scenario is dependent on whether a non-contiguous transmission of more than one PSFCH is feasible.

Proposal 6: Study an adaptive HARQ retransmission protocol to prevent continuous collisions, if a PSSCH resource is implicitly linked to a PSFCH resource.

33.

When one UE is receiving multiple transmissions from another UE, the receiving UE is expected to send back multiple HARQ feedbacks for each of the transmissions. If the PSFCH resources are the same for any of the transmissions, a collision would occur.

In this case, the straightforward solution is to transmit multiple HARQ-ACK bits in a single PSFCH. However, an issue arises when the receiver UE misses one of the SCIs associated with the same PSFCH. This would lead to a mismatch in the number of bits transmitted by the receiver UE and the number of bits expected by the transmitter UE. The transmitter UE would be unable to decode the feedback it received, and this has to be studied further.

Proposal 7: Support multiple HARQ-ACK bits in a PSFCH for N>1.

Proposal 8: Study how to handle the missing of SCIs in case multiple HARQ-ACK bits in a PSFCH are supported.

### 4. Conclusion

Based on the above identified analysis carried out in this contribution, embodiments provide the following:

Realization 1: to support different SCI formats for different communication types, with at least one for unicast and groupcast, and one for broadcast communications.

Realization 2: that the resource pool configuration contains the SCI formats to be monitored by the UE.

Realization 3: that the CRC of an SCI is not scrambled by the destination L1 ID to allow Mode 2 UEs to detect Mode 1 transmissions.

Realization 4: to support CBG-based HARQ-ACK at least for the case of transmissions spanning multiple time and/or frequency resources.

Realization 5: Prioritize PSFCH transmissions/receptions based on a criteria, such as QoS, in cases of possible PSFCH resource collisions.

Realization 6: Study an adaptive HARQ retransmission protocol to prevent continuous collisions, if a PSSCH resource is implicitly linked to a PSFCH resource.

Realization 7: Support multiple HARQ-ACK bits in a PSFCH for N>1.

Realization 8: Study how to handle the missing of SCIs in case multiple HARQ-ACK bits in a PSFCH are supported.

In the following, additional embodiments and aspects of the invention will be described which can be used individually or in combination with any of the features and functionalities and details described herein.

According to a first aspect, a device is configured to operate in a wireless communication network being operated so as to comprise a feedback channel providing feedback resources to acknowledge reception of transmitted messages transmitted in the wireless communication network; wherein the device is to acknowledge a received message e.g., a control message of a PSSCH, by transmitting a first feedback message using a specific feedback resource; and for awaiting an acknowledge transmission; wherein the device is configured to await reception of a second acknowledge message transmitted by use of the same or another specific feedback resource; wherein the device is configured for postponing or omitting transmission of the first feedback message so as to receive the second feedback message.

According to a second aspect when referring to the first aspect, the first and second feedback message are to be transceived within the same time interval (e.g TTI or slot).

According to a third aspect when referring to the first or second aspect, the first and second feedback resource are to be transceived within the same time interval (e.g TTI or slot).

According to a fourth aspect when referring to any of the previous aspects, the device is configured for postponing or omitting the transmission of the first feedback message in case the first feedback message is a negative feedback.

According to a fifth aspect when referring to any of the previous aspects, the device is configured for transmitting the first feedback message responsive to a successful decoding of the received message using the specific resource.

According to a sixth aspect when referring to any of the previous aspects, the device is configured for postponing or omitting the transmission of the first feedback message based on at least one of: the QoS of the received message and/or the message to be acknowledged, e.g. indicated as a priority level, a packet size of the received message and/or the message to be acknowledged, a buffer status of the device, a battery status of the device, a delay budget of the device and/or a decoding outcome (HARQ result to be reported).

According to a seventh aspect when referring to the sixth aspect, the device is configured for operating according to a half-duplex scheme and for prioritizing either transmission of the first feedback message or reception of the second feedback message over the other.

An eighth aspect relates to a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources, wherein the device is to acknowledge a received message (e.g., a control message of a PSSCH) by transmitting a first feedback message using a specific feedback resource; and for awaiting an acknowledge transmission; wherein the device is configured to await a second acknowledge message transmitted by use of the specific feedback resource; wherein the device is configured for transmitting the first feedback message and for assuming the second feedback message to comprise a predefined content.

According to a ninth aspect when referring to the eighth aspect, the predefined content is a negative feedback (NACK).

According to a tenth aspect when referring to the ninth aspect, the device is configured for retransmitting a message being a basis for the second feedback signal responsive to the assumed negative feedback.

An eleventh aspect relates to a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources; wherein the network is organized such that one or more messages transmitted to a receiver are to be acknowledged by the receiver in a combined feedback message; wherein the device is configured to sense the network for transmitted messages, to determine a receiver of the transmitted messages and for selecting a slot for an own transmission based on the sensed transmitted message to avoid feedback collisions.

According to a twelfth aspect when referring to the eleventh aspect, all or some of the feedback messages for one resource are referring to transmitted messages in different or consecutive time intervals (e.g. slots or TTIs).

According to a thirteenth aspect when referring to the eleventh or twelfth aspect, to avoid feedback collisions the transmission resource is selected so that the own transmission is acknowledged by the receiver of the own transmission together with a message of the transmitted messages and/or that the own transmission is acknowledged by the receiver of the own transmission without colliding with the transmissions of other acknowledgements.

A fourteenth aspect relates to a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources; wherein the network is organized such that resources used for transmission of a message are associated with resources used for corresponding feedback signals; wherein the device is configured to determine a first receiver of a first transmitted message; and, for transmitting an own message to a second receiver, avoid resources that the receiver of the own transmission is expected to use to also send its feedback message using the same resources as the first receiver.

A fifteenth aspect relates to a device configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources; wherein the network is organized such that resources used for transmission of a message are associated with resources used for corresponding feedback signals; wherein the device is configured for determine a first receiver of a first transmitted message; and, for transmitting an own message to the first receiver, use resources that are deemed to be used by the first receiver to send its feedback message.

A sixteenth aspect relates to a device or network configured to operate in a wireless communication network being operated so as to comprise a feedback channel providing feedback resources to acknowledge reception of transmitted messages transmitted in the wireless communication network; wherein a number of transmitted messages is larger when compared to a number of feedback resources, wherein the network is organized such that resources used for transmission of a message are associated with resources used for corresponding feedback signals; wherein the device is to determine a number of feedback signals in a feedback resource, and wherein another device (receiver or transmitter of feedback) is to determine a same number of feedback signals.

According to a seventeenth aspect when referring to the sixteenth aspect, the device is to use a preconfigured number of feedback signals as default.

According to an eighteenth aspect when referring to the sixteenth or seventeenth aspect, the device is to transmit to another device a number of feedback signals to use.

According to a nineteenth aspect when referring to the sixteenth or eighteenth aspect, the device is to receive from another device a number of feedback signals to use.

According to a twentieth aspect when referring to any of the sixteenth to nineteenth aspects, the device is to determine the number of feedback resources from the PSFCH periodicity which is signaled by the network as part of the resource pool configuration.

According to a twenty-first aspect when referring to the twentieth aspect, the number of feedback resources is equal to the PSFCH periodicity.

According to a twenty-second aspect when referring to any of the sixteenth to twenty-first aspects, the device is to perform a feedback reduction operation, if the number of feedback signals is less than the number of transmissions or the number of associated transmission resource or associated slots.

According to a twenty-third aspect when referring to the twenty-second aspect, the feedback reduction operation is an AND operation.

According to a twenty-fourth aspect when referring to any of the previous aspects, the device is a transceiver.

According to a twenty-fifth aspect when referring to any of the previous aspects, the device comprises at least one of: a user equipment; a mobile or immobile base station, a mobile terminal, a stationary terminal, a cellular IoT-UE, a vehicular UE, a group leader UE (GL), an IoT or narrowband IoT, NB-IoT, device, a ground based vehicle, an aerial vehicle, a drone, a moving base station, a road side unit (RSU), a building, and any other item or device provided with network connectivity enabling the item/device to communicate using the wireless communication network, e.g., a sensor or actuator.

A twenty-sixth aspect relates to a device comprising any combination of features according to the present disclosure and/or aspects.

A twenty-seventh aspect relates to a wireless communication network being operated so as to comprise a feedback channel providing feedback resources to acknowledge reception of messages transmitted in the wireless communication network; wherein a number of messages is larger when compared to a number of feedback messages enabled by the feedback resources; the network comprising: at least two devices according to one of previous aspects.

According to a twenty-eighth aspect when referring to the twenty-seventh aspect, the wireless communication network further comprises one or more base stations.

According to a twenty-ninth aspect when referring to the twenty-eighth aspect, the at least one base station is implemented as mobile or immobile base station and comprises one or more of a macro cell base station, a small cell base station, a central unit of a base station, a distributed unit of a base station, a road side unit, a UE, a group leader (GL), a relay, a remote radio head, an AMF, an SMF, a core network entity, a mobile edge computing entity, a network slice as in the NR or 5G core context, and any transmission/reception point, TRP, enabling an item or a device to communicate using the wireless communication network, the item or device being provided with network connectivity to communicate using the wireless communication network.

A thirtieth aspect relates to a method for operating a device to operate in a wireless communication network being operated so as to comprise a feedback channel providing feedback resources to acknowledge reception of transmitted messages transmitted in the wireless communication network; the method comprising: acknowledging a received message e.g., a control message of a PSSCH, by transmitting a first feedback message using a specific feedback resource; awaiting an acknowledge transmission; awaiting reception of a second acknowledge message transmitted by use of the same or another specific feedback resource; postponing or omitting transmission of the first feedback message so as to receive the second feedback message.

A thirty-first aspect relates to a method for operating a device to operate in a wireless communication network being operated so as to comprise a feedback channel providing feedback resources to acknowledge reception of transmitted messages transmitted in the wireless communication network; wherein a number of transmitted messages is larger when compared to a number of feedback resources; the method comprising: acknowledging a received message (e.g., a control message of a PSSCH) by transmitting a first feedback message using a specific feedback resource; awaiting an acknowledge transmission; awaiting a second acknowledge message transmitted by use of the specific feedback resource; and transmitting the first feedback message and for assuming the second feedback message to comprise a predefined content.

A thirty-second aspect relates to a method for operating a device to operate in a wireless communication network being operated so as to comprise a feedback channel providing feedback resources to acknowledge reception of transmitted messages transmitted in the wireless communication network; wherein a number of transmitted messages is larger when compared to a number of feedback resources; the method comprising: organizing the network such that one or more messages transmitted to a receiver are to be acknowledged by the receiver in a combined feedback message; operating the device to sense the network for transmitted messages, to determine a receiver of the transmitted messages and for selecting a slot for an own transmission based on the sensed transmitted message to avoid feedback collisions.

A thirty-third aspect relates to a method for operating a device to operate in a wireless communication network being operated so as to comprise a feedback channel providing feedback resources to acknowledge reception of transmitted messages transmitted in the wireless communication network; wherein a number of transmitted messages is larger when compared to a number of feedback resources; the method comprising: organizing the network such that resources used for transmission of a message are associated with resources used for corresponding feedback signals; operating the device to determine a first receiver of a first transmitted message; and, for transmitting an own message to a second receiver, avoid resources that the receiver of the own transmission is expected to use to also send its feedback message using the same resources as the first receiver.

A thirty-fourth aspect relates to a method for operating a device to operate in a wireless communication network being operated so as to comprise a feedback channel providing feedback resources to acknowledge reception of transmitted messages transmitted in the wireless communication network; wherein a number of transmitted messages is larger when compared to a number of feedback resources; the method comprising: organizing the network such that resources used for transmission of a message are associated with resources used for corresponding feedback signals; operating the device to determine a first receiver of a first transmitted message; and, for transmitting an own message to the first receiver, use resources that are deemed to be used by the first receiver to send its feedback message.

A thirty-fifth aspect relates to a method for operating a device to operate in a wireless communication network being operated so as to comprise a feedback channel providing feedback resources to acknowledge reception of transmitted messages transmitted in the wireless communication network; wherein a number of transmitted messages is larger when compared to a number of feedback resources; the method comprising: organizing the network such that resources used for transmission of a message are associated with resources used for corresponding feedback signals; operating the device to a number of feedback signals in a feedback resource, and operating another device (receiver or transmitter of feedback) to determine a same number of feedback signals.

A thirty-sixth aspect relates to a computer readable digital storage medium having stored thereon a computer program having a program code for performing, when running on a computer, a method according to one of aspects 30 to 35.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

Note other scenarios can benefit of the described mechanism. Here, the following are to be mentioned:
Networks with Internet-of-Things (IoT) devices,
Vehicular to Vehicular (V2V) devices or Vehicular to Anything (V2X) devices,
Narrowband IoT (NB-IoT) systems with limited power source, which use D2D for relaying information to another device,
Light NR-systems, which support a smaller bandwidth and thus need D2D to deliver data rates to another device or core network,
Industrial IoT (IIOT) networks which support D2D communications,
Public protection disaster relief (PPDR)-systems, which use D2D for communication or as range extension.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] RP-190984, “Revised WID on 5G V2X with NR sidelink”, LG Electronics, Huawei, 3GPP RAN #84, June 2019.
[2] Chairman's Notes, TSG RAN WG1 #96bis, April 2019.
[3] 3GPP TR 38.885, “Study on NR Vehicle-to-Everything (V2X)”, V2.0.0, March 2019.
[4] R1-1908677, “Design of NR V2X Physical Layer Structures”, Fraunhofer HHI, Fraunhofer IIS, 3GPP RAN1 #98, August 2019.

1. A device comprising:
a processor circuit and a memory circuit, wherein the memory circuit is arranged to store instructions executable by the processor circuit,
wherein the processor circuit is arranged to acknowledge a received message by transmitting a feedback message using a feedback resource,
wherein the feedback message comprises a destination user equipment (UE) that transmitted the received message,
wherein the feedback resource is allocated to a plurality of user equipments (UEs),
wherein the plurality of UEs includes the device,
wherein the plurality of UEs are arranged to communicate communication messages using one or more slots of a frame of a subchannel,
wherein the processor circuit is arranged to monitor prior slots of a current frame of the subchannel to determine if at least one other UE of the plurality of UEs has communicated a control message in any of the prior slots, and
wherein the processor circuit is arranged to transmit the feedback message in dependence upon whether the at least one other UE has communicated the control message in any of the prior slots.

2. The device of claim 1, wherein, if none of the at least one other UE has communicated the command message in the one or more prior slots, the processor circuit is arranged to transmit the feedback message.

3. The device of claim 1,
wherein, if the other UE has communicated the control message in the prior slot, the processor is arranged to:
decode the control message in the prior slot to determine a destination UE of the payload message,
transmit the feedback message only if the destination UE of the feedback message corresponds to the destination of the control message.

4. The device of claim 1,
wherein, if the other UE has communicated the control message in the prior slot, the processor is arranged to:
identify an alternative feedback resource,
wherein the alternative feedback resource is allocated to the destination UE of the feedback message, and
communicate the feedback message using the alternative feedback resource.

5. The device according to claim 1, wherein the device is a transceiver.

6. The device according to claim 1, comprising at least one of:
a mobile or immobile base station,
a mobile terminal,
a stationary terminal,
a cellular Internet of Things User Equipment,
a vehicular User Equipment,
a group leader User Equipment,
an Internet of Things or narrowband Internet of Things device,
a ground based vehicle User Equipment,
an aerial vehicle User Equipment,
a drone User Equipment,
a roadside unit, and
a sensor or actuator.

7. A method comprising:
receiving a received message from a transmitting device,
determining whether to acknowledge the received message by transmitting a first feedback message using a first feedback resource;
wherein the feedback message comprises a destination user equipment (UE) corresponding to the transmitting device,
wherein the feedback resource is allocated to a plurality of user equipments (UEs),
wherein the plurality of UEs includes the device,
wherein the plurality of UEs are arranged to communicate control messages using one or more slots of a frame of a subchannel,
monitoring prior slots of a current frame of the subchannel to determine if at least one other UE of the plurality of UEs has communicated a control message in any of the prior slots, and
transmitting the feedback message in dependence upon whether the at least one other UE has communicated the control message in any of the prior slots.

8. The method of claim 7, comprising transmitting the feedback message if none of the at least one other UE has communicated the command message in the one or more prior slots.

9. The method of claim 7,
wherein, if the other UE has communicated the control message in the prior slot, the method comprises:
decoding the control message in the prior slot to determine a destination UE of the control message,
transmitting the feedback message only if the destination UE of the feedback message corresponds to the destination UE of the control message.

10. The method of claim 7
wherein if the other UE has communicated the control message in the prior slot, the method comprises:
identifying an alternative feedback resource,
wherein the alternative feedback resource is allocated to the destination UE of the feedback message, and
transmitting the feedback message using the alternative feedback resource.

11. A non-transitory computer-readable medium comprising a computer program that, when executed on a processor, performs the method as claimed in claim 7.
